(19) United States
(12) Patent Application Publication
(10) Pub. No.: US 2020/0024534 A1
(43) Pub. Date: Jan. 23, 2020

(54) METHOD AND SYSTEM FOR DESULFURIZATION AND DEZINCIFICATION OF HIGH-SULFUR COAL

(71) Applicant: KUN-LIANG HONG, TAINAN CITY (TW)

(72) Inventor: KUN-LIANG HONG, TAINAN CITY (TW)

(21) Appl. No.: 16/412,556

(22) Filed: May 15, 2019

(30) Foreign Application Priority Data
Jul. 18, 2018 (TW) 107124846

(51) Int. Cl. C10L 5/02; C01B 17/16; B01D 53/00; C02F 1/461

(52) U.S. Cl. CPC C10L 5/02; C01B 17/16; B01D 53/002; C02F 1/4618; C10L 2290/38; C10L 2290/06; C10L 2290/08; C10L 2290/544; C02F 2001/46185

(57) ABSTRACT

A method for desulfurization and dezincification of high-sulfur coal includes the steps of passing tap water into a high oxidation reduction electrocatalytic water equipment to reduce the pH value to 1-2, mixing the pH value 1-2 acid electrocatalytic water thus obtained with the high-sulfur coal, and heating the mixture to let H⁺ in the acid electrocatalytic water be reacted with sulfur and nitrogen in the high-sulfur coal to cause generation of hydrogen sulfide gas and ammonia where the volatilization of water vapor effectively removes the sulfur and nitrogen in the high-sulfur coal and the hydrogen sulfide and ammonia gases thus generated are collected.

### BACKGROUND OF THE INVENTION

### 1. Field of the Invention

The present invention relates to mineral processing technology and more particularly, to a method for desulfurization and dezincification of high-sulfur coal. The invention relates also to a system for the implementation of the method for desulfurization and dezincification of high-sulfur coal.

### 2. Description of the Related Art

Coal is one of the most abundant fossil fuels on the earth and the most important source of energy in China. However, China's coal resources have a high average sulfur content, of which high sulfur reserves of >2% of total sulfur account for about one-third of total coal reserves, accounting for about one-sixth of the coal produced.

High-sulfur coal produces a large amount of SO₂ and nitride during processing and utilization, which is the main cause of atmospheric pollution and acid rain. China's air pollution is dominated by soot-type pollution. The SO₂ emitted by coal combustion deteriorates the environmental quality of the atmosphere and the acid rain is aggravated. Therefore, controlling SO₂ in the flue gas becomes an urgent task.

As people's awareness of environmental protection increases, coal users are increasingly demanding the total sulfur content of coal used in processing. China has listed coal desulfurization as a research project for Clean Coal Technology (CCT).

Therefore, coal desulfurization is an important research topic, and solving it has great practical significance. There are many ways to control SO² emissions. The combination of source control and end treatment should be adhered to.

According to the different stages of the desulfurization process in the coal utilization process, coal desulfurization can be divided into desulfurization before combustion, desulfurization in combustion and desulfurization after combustion. Desulfurization before coal combustion removes sulfur from coal before combustion, avoids the change of sulfur in combustion, reduces sulfur content in flue gas, reduces corrosion on tail flue, and reduces operating and maintenance costs. Desulfurization before combustion has many potential advantages over the other two desulfurization processes, and it is in line with the “prevention-oriented” approach. Because many household coal, medium and small boilers use a large amount of coal, the source is different, it is difficult to control, so it is of great significance to remove sulfur to a certain range of pre-combustion desulfurization in the coal preparation plant.

### The Main Forms of Sulfide in Coal

Sulfur is the main harmful impurity in coal, and its content varies greatly from 0.1% to 10%. The sulfur content of most coal is about 0.5%˜3.0%. Common sulfide minerals in coal are mainly iron pyrite, as well as white iron, pyrrhotite, chalcopyrite, sphalerite, galena, orpiment, realgar and so on.

Iron pyrite (FeS₂, equiaxed crystal system) is the main source of inorganic sulfur in coal, and it is also the part that can be removed by physical methods. According to the 90-year coal seam sulfur analysis, China's 170 high-sulfur coal and high-sulfur coal mines (sulfur content greater than 2%), the cumulative total sulfur is 2.56%, of which pyrite sulfur 1.39%, sulfate sulfur 0.1%, organic sulfur 1.01%, that is, pyrite sulfur accounts for 54.3% of total sulfur.

White iron (FeS2, orthorhombic) is self-shaped, semi-automorphic, radial, granular, concentric annular aggregate or tuberculosis, and its shape is mostly round. White iron can also be used as a package. White iron can also be used as a cladding to coat multiple raspberry or globular iron pyrite. The content of other sulfide minerals in coal, such as chalcopyrite, sphalerite, galena, etc., mostly in the form of particulates, granular aggregates and irregularities is small. Self-formed crystal, semi-automorphic crystal is less, fineness is mostly 2˜15 μm, distributed in unstructured vitrinite, clay microscopic stratification, and structural vitrinite and silky body cavity.

### The Main Forms of Nitrogen in Coal

The nitrogen in coal is derived from the protein, amino acid, alkaloid, chlorophyll and porphyrin contained in coal-forming plants and strains. The nitrogen content in coal is 0.5%˜2.5%. Since the nitrogen in the coal is fixed in the peat stage, nitrogen is almost entirely in the form of organic matter, mainly pyrrole type, pyridine type and quaternary nitrogen.

Discover using XANEX: Pyrrole-type nitrogen is the main form of nitrogen in coal, which is contained in lignite to anthracite, accounting for 50%˜80% of total nitrogen. Pyridine nitrogen is also a common nitrogen-containing form, and its content increases with the increase of coal rank, generally 0˜20%. The quaternary nitrogen is the form of another nitrogen in coal, and its content is 0˜3%.

### According to Wojtowicz's Research

(1) The most nitrogenous component of coal is the five-membered ring pyrrole type, which decreases from about 80% of bituminous coal to about 55% of anthracite. As the coal rank increases, the five-member ring gradually transitions to a more stable six-member ring.

(2) The pyridine content increases with coal rank, from about 10% of bituminous coal to about 40% of higher rank coal.

(3) The content of quaternary nitrogen is not affected by the coal rank, and its composition accounts for up to about 20%. The relationship between various nitrogen contents and coal ranks is shown in FIG. 4.

The percentages of the forms of nitrogen present from the above literature are not identical, mainly because the coal used is different, but the trend is almost the same. People hold different views on whether the NHi group exists in coal. In the coal samples studied by Nelson et al., pyridine, pyrrole and quaternary nitrogen were detected by XANES, but no NHi group was found. It has been hypothesized that NHi is present in all low rank coals but cannot be detected by XPS because the amount of NHi is too small and the position of the NHi peak is between the nitrogen-containing five-membered ring and the nitrogen-containing six-membered ring. Therefore, there is very little evidence that an amino group exists. In addition, people also found a very meaningful six-membered ring containing nitrogen in the research process: Pyridone (N-6(0)), which is closely related to quaternary nitrogen, is difficult to detect with XPS because its N(1S) can be similar to the N(1S) of pyrrole and can only be detected by XANES. These nitrogen-containing substances are either present in the coal as small molecules or crosslinked with the aromatic ring by covalent bonds. When heated, they are released as different nitrogen compounds.

### Research Status of Coal Flotation Desulfurization

At present, a variety of coal preparation technologies for desulfurization have been developed at home and abroad, including physical coal preparation, chemical coal preparation and biological coal preparation. Among them, chemical or biological methods can effectively remove inorganic sulfur and organic sulfur, but the reaction conditions are harsh, and it is not yet available for commercial production on a large scale. Although the physical method cannot remove organic sulfur, China's high-sulfur coal has the highest inorganic sulfur content, which can be realized and promoted by using existing coal preparation technology and appropriate coal preparation method. This method is simple and easy to implement, and has less changes to the existing process flow, less investment, and quick effect. In physical coal preparation, there are mainly gravity desulfurization, flotation desulfurization, high gradient magnetic separation desulfurization, oil agglomeration and high-pressure electrostatic coal preparation technology desulfurization. These methods have their own advantages and disadvantages in terms of technology. From the point of view of actual production, except for the flotation method, other methods have not been applied to large scale due to technology or economic constraints.

### (I) Gravity Desulfurization

Gravity desulfurization is to use the difference in density between coal and iron pyrite, hydrocyclone and shaker as the sorting equipment, separating the two. In China, +0.5 mm coarse-grain coal desulfurization generally adopts re-election method, such as jigging, shaker, water medium cyclone, etc., which have good desulfurization effect. In this regard, Tangshan Coal Research Institute has done a lot of research work.

Shanxi Coal Chemical Research Institute used 3˜0 mm coal samples in the horizontal centrifuge with ZnCl₂ and heavy liquid to show that it can remove 80%˜85% of iron pyrite. However, due to that ZnCl₂ is strongly corrosive and difficult to recycle, there is no prospect of industrial implementation for this method.

### (II) Biological Desulfurization

Microbial desulfurization is the desulfurization by biological redox reaction under normal pressure and mild conditions below 100° C.

During the 1950 s and 1960 s, Ashamed, Leadhen, Temple, and Zarutina introduced the Thiobacillus ferrooxidans isolated from the acid veins of coal mines into the coal preparation process, marking the beginning of microbial desulfurization.

In 1961, Sliverman's research on the physiological and biochemical characteristics of the strain laid the foundation for the mechanism of microbial removal of pyrite. At present, the microorganisms widely used in coal desulfurization research are Thiobacillus ferrooxidans and Thiobacillus thiooxidans, and CB1 and CB2 isolated from natural biological populations by ARCTECH Inc. in the late 1980 s. It is said that the latter two have a special effect on the removal of thiophene sulfur in coal.

Laboratory microbial removal of FeS₂ in coal has been extensively studied and has achieved gratifying results. The researchers used a mixed population of Thiobacillus ferrooxidans and Thiobacillus thiooxidans or other integrated populations to remove more than 90% of pyrite sulfur. Microbial removal of organic sulfur started in the late 1970 s. The population used to remove organic sulfur is difficult to culture, and the treatment cycle is longer. The general desulfurization rate is between 10 and 57%. ARCTECH Inc. research results show that the microbial organic sulfur removal rate depends on the coal type, particle size, raw coal organic sulfur content and other unknown parameters.

China has also done a lot of work on biological and microbial desulfurization. As early as 1984˜1986, China University of Mining and Technology conducted research on microbial desulfurization of pine algae coal. The removal rate of pyrite was 70% in 8 days. Now the removal rate of iron pyrite has reached 90%, the organic sulfur removal rate is about 40%, and the method has reached the pilot scale.

Although laboratory desulfurization has been carried out extensively, semi-industrial research is very immature. Only semi-industrial economic analysis based on 1 ton/day coal is reliable.

However, the industrialization of microbial desulfurization faces a severe economic test. Since it is necessary to supply the necessary expensive chemicals and reactors to the system, and the treatment cycle is long, the process requires pH adjustment, etc., resulting in extremely high processing costs and difficulty in industrialization.

(III) Chemical Desulfurization of Coal

Because chemical desulfurization has the characteristics of high reactivity and high desulfurization rate, extensive research has been carried out in the laboratory in recent years. At present, chemical desulfurization mainly uses two methods of oxidation and replacement.

60%˜70% of iron pyrite is removed with lye at 120° C.˜150° C., but the product has a certain amount of calorific value loss.

95% of iron pyrite is removed from coal with 1.0 mol/L FeCl3 at 102° C.

Treating Thai coal with 15% H₂O₂ and 0.1 mol/L H₂SO₄ under mild conditions of 30° C., it removes 65% ash, 10% organic sulfur, almost all iron pyrite and sulfate sulfur in 2 hours.

The laboratory used Co60 to induce the irradiation of acid coal slurry under oxidizing conditions, removing 29% of the ash-forming minerals, 68% sulfate sulfur, 80% pyrite sulfur and 67.5% organic sulfur in the coal.

Remove 80%˜90% of total sulfur in half an hour with molten NaOH—KOH. At present, the advanced molten alkali desulfurization process can remove more than 95% of ash-forming minerals and 90% of total sulfur. The process not only removes inorganic sulfur but also removes organic sulfur, which is the most effective method for removing organic sulfur. Microwave radiation mixture of molten alkali and coal can greatly improve the desulfurization rate of coal and shorten the processing time.

Microwave treatment of coal samples at 573˜623K for 4-6 minutes can remove 90% of organic sulfur. China East China Institute of Chemical Technology conducted a microwave chemical melting desulfurization laboratory test on Wuda, Xinwen, Suncun and Zaozhuang raw coal. Experiments show that more than 90% of the iron pyrite and sulfate sulfur in the raw coal can be removed, and the removal rate of organic sulfur is between 35% and 74%.

Due to the high reaction conditions of the alkali fusion method, it is difficult to recover the alkali liquor, and it is difficult to put into industrial application in the short term as well as the oxidation method.

### (IV) Selective Oil Agglomeration and Selective Flocculation Desulfurization

Selective flocculation desulfurization is a form of selective sorting process, which is based on the difference of physical and chemical properties of coal and iron pyrite surface.

The dispersant can be selectively adsorbed on the surface of the iron pyrite, and the amount of adsorption on the surface of the coal is small, thereby realizing the separation of coal and iron pyrite. The experiment shows that: 71.5% of the iron pyrite in the raw coal can be removed by using the dispersant at a solid concentration of 2.8% or less.

Selective flocculation in China is also a relatively studied one. Zhang Mingxu of China University of Mining and Technology used the selective flocculant FR-7A to carry out desulfurization experiments on 3.27% sulfur-containing fine-grained high-sulfur coal samples. It was found that under the best conditions, the iron pyrite removal rate was 75%. This is a good indicator. Cai Wei and Liu Hongyu from China University of Mining and Technology conducted experiments on the K7 coal mud sample of Zhongliangshan Lindong. The results show that the removal rate of iron pyrite sulfur is above 80% and the total sulfur content can be reduced to below 0.5%.

Because selective flocculation is limited by the treatment volume of the coal washing plant, and the flocculation time is long, the separation of flocs and dispersions needs to be solved. Therefore, this method cannot be widely promoted at present, and it is impossible to apply it to industrial desulfurization in a short period of time. The fatal weakness of the oil agglomeration sorting method is that the fuel consumption is too high, and it is difficult to achieve industrial application. Therefore, the oil agglomeration method should be technically and economically feasible, and two problems must be solved: the first is to solve the problem of the dissociation degree of the feed; the second is to solve the problem of high fuel consumption.

### (V) Overview of HGMS Desulfurization Process Research

In China, in 1984, Deng Nian's new high-gradient magnetic separator modified by XCQS wet magnetic separator was used to treat Zhongliangshan coal. It can be recovered from St=6.16%, Ad=30.0% of the sample with 2.08% sulfur and 21.56% ash. Clean coal yield is 66%. In 1988, Fan Chenggang used a continuous Sala high-gradient magnetic separator to treat

Zhongliangshan clean coal at IT. The results of semi-industrial experiments showed that 60.7% of sulfur and 42.5% of ash could be removed by the clean coal yield of 71.6%, and the treatment volume was 80 Kg/h. In 1993, Zheng Jianzhong used CHG---10HGMS to treat Nantong raw coal. Semi-industrial experiments showed that more than 70% of iron pyrite sulfur was removed when the yield of clean coal was above 60%.

Unfortunately, the current HGMS generally has a low field strength and a low gradient, and the clogging phenomenon often occurs in the sorting tank. The magnetic susceptibility of iron pyrite is 1/10- 1/100 of ordinary metal minerals. It is not easy to apply such a magnetic separator to the separation of low magnetization coefficient coal/iron pyrite, and the cost of superconducting HGMS is too high to be industrialized.

### SUMMARY OF THE INVENTION

The present invention has been accomplished under the circumstances in view. It is therefore the main object of the present invention to provide a method for desulfurization and dezincification of high-sulfur coal, which is to pass the tap water into a high oxidation reduction electrocatalytic water equipment for enabling the pH value of the tap water to be reduced to 1-2. The high oxidation reduction electrocatalytic water equipment is a reactor for continuously generating high oxidation reduction water as described in China Utility Application 201120312616.4, no more instruction here. The pH value 1-2 acid electrocatalytic water thus obtained is then mixed with high-sulfur coal subject to a specific formula, and then the mixture is heated for a short period of time. In the process of heating, a large amount of H⁺ in the acid electrocatalytic water is reacted with sulfur and nitrogen in the high-sulfur coal, and hydrogen sulfide gas and ammonia are generated. In the process of heating, the volatilization of water vapor can effectively remove the sulfur and nitrogen in the high-sulfur coal, thereby improving the quality of the coal to meet the steelmaking requirements. The hydrogen sulfide gas and ammonia thus generated are collected into the ultra-gas battery flow device through a pipeline for further decomposition treatment. After high-sulfur iron desulfurization and dezincification, the total carbon content is increased, the quality is also improved correspondingly, and the level of steelmaking is reached, so that the high-sulfur coal which could not be used can be re-used as reusable coal.

The exhaust gas generated by the heating process is guided into the gas-liquid separator where water vapor is separated from the exhaust gas. The exhaust gas is soluble gas. The water vapor is then guided into the circulating water recovery treatment tank while the exhaust gas is guided into the ultra-gas battery flow device for treatment. The ultra-gas battery flow device is the technology of China Patent Application 201310090394.X “Catalyst plasma and tunnel plasma containing the same” and 201010217588.8 “Uniform electric field dielectric discharge reactor” that were invented and filed by the applicant. After high-sulfur iron desulfurization and dezincification, the total carbon content is increased, the quality is also improved correspondingly, and the level of steelmaking is reached, so that the high-sulfur coal which could not be used can be re-used as reusable coal.

The principle of electrocatalytic water used in the method of the invention for modifying the surface of coal is as follows:

### 1. Electron Transfer Mechanism

The coal particles are directly obtained by electrons, and the reaction course is as follows:

### (1) Ether Bond Reduction

RCH₂—O—CH₂R′+4H.+e→R—CH₃+R′—CH₃+H₂O

### (2) Hydroxyl Reduction

ROH+2H⁺+e→RH+H₂O

### (3) Carbonyl Reduction

ArR′C═O+2H⁺+e→ArR′CH₂OH+H₂O

### (4) Carboxyl Reduction

RCOOH+H⁺+e→RH+CO₂

RCHO+H⁺+e→RCHO+H₂O

RCH₂+H⁺+e→RCH₂OH

RCH₂OH+H⁺+e→RCH₃+H₂O

### 2. Active H. Action Mechanism

First, electrocatalytic water reacts H₂O to produce a lively free H.

H⁺+e→H.

Then, free H. acts with the surface of coal —OH, —O, >C═O, —COOH:

Ar—OH+H.→[Ar.]+H₂O

[Ar.]+H.→ArH

[Ar.]+[Ar.]→Ar—Ar

Similarly, the reaction history of H. and >C═O, —COOH is similar to the above.

### 3. Support for Electrolytes

When HCl is used as the supporting electrolyte, the reaction mechanism is presumed to be:

[coal]⁻+H⁺→[coal]H

In short, under certain electrochemical conditions, the modification result of the coal surface is: The oxygen-containing functional groups in the coal surface structure are reduced, and the adsorbed oxygen content on the coal surface is also reduced, thereby improving the floatability of the coal; at the same time, the organic sulfur in the coal is reduced to a hydrophilic S²⁻, separated from the coal to achieve the purpose of desulfurization.

Principle of electrocatalytic water treatment of sulfur in coal: In addition to the sulfur in the organic matter in coal, there are also inorganic forms, mainly represented by FeS₂. The following is the principle of converting FeS₂ into sulfur-containing waste gas:

FeS₂+2H+═Fe²⁺+S↓+H₂S↑

4FeS₂+11O₂═2Fe2O₃+8SO₂↑

2H₂S+SO₂═2H₂O+3Sθ(Centralization reaction)

### The Treatment of Hydrogen Sulfide in the Method of the Invention Shows

### The Nature of Hydrogen Sulfide

### The Nature of Hydrogen Sulfide

Molecular Structure: The central atom S atom adopts sp³ hybridization (actually, the result calculated by the bond angle is close to p³ hybridization). The electron pair configuration is a regular tetrahedron shape. The molecular configuration is V-shaped, and the H—S—H bond angle is 92.1°. The dipole moment is 0.97 D. It is a polar molecule. Due to the weak H-S bond, hydrogen sulfide decomposes around 300° C.

Flash point: 260° C. Saturated vapor pressure: 2026.5 kPa/25.5° C. Solubility: Soluble in water (dissolved ratio 1:2.6), ethanol, carbon disulfide, glycerin, gasoline, kerosene, etc.

Critical temperature: 100.4° C. Critical pressure: 9.01 MPa.

Color and smell: Hydrogen sulfide is colorless, highly toxic, acid gas. Hydrogen sulfide has a special smell of rotten eggs. Olfactory threshold: 0.00041 ppm. Even low concentrations of hydrogen sulfide can damage human sense of smell. When the concentration is high, there is no smell (because high concentration of hydrogen sulfide can paralyze the olfactory nerve). Using the nose as a means of detecting this gas is fatal. The relative density is 1.189 (15□,0.10133 MPa).

Explosion limit: Explosion if mixed with air or oxygen in an appropriate ratio (4.3% to 46%).

Flammability: The completely dry hydrogen sulfide does not react with oxygen in the air at room temperature, but it can be burned in the air during ignition. It burns in drilling and downhole operations, and the burning rate is only about 86%. When the hydrogen sulfide burns, it produces a blue flame and toxic sulfur dioxide gas. The sulfur dioxide gas will damage the eyes and lungs. When the air is sufficient, SO₂ and H₂O are formed. If the air is insufficient or the temperature is low, free S and H₂O are formed.

### The Chemical Reaction Principle in Exhaust Gas Treatment in the Ultra-Gas Battery Flow Device

H₂S+e⁻=H₂↑+S↓

SO₂+e⁻=O₂↑+S↓

2H₂S+SO₂═H₂O+3S↓

### Efficacy of the Present Invention When Compared With the Prior Art Technique

The method of the invention is controlled by the high oxidation reduction electrocatalytic water equipment to reduce the pH value of the tap water to 1-2. A specific ratio of the pH value 1-2 acid electrocatalytic water is mixed with high-sulfur coal subject to a specific formula and then heated for a short period of time. In the process of heating, a large amount of H⁺ in the acid electrocatalytic water is reacted with sulfur and nitrogen in the high-sulfur coal, and hydrogen sulfide gas and ammonia gas are generated. In the process of heating, the volatilization of water vapor can effectively remove the sulfur and nitrogen in the high-sulfur coal, thereby improving the quality of the coal to meet the steelmaking requirements.

### The Advantages of This Method

1. The economic benefits are large; after collecting some abandoned high-sulfur coal and then processed, the sales price can reach 100-200 yuan (RMB)/ton.

2. At the same time, the sulfur and nitrogen in the coal are removed, the carbon content of the coal will increase, and a large amount of coal-fired power plants, smelters and other large coal mines will be saved.

3. High-sulfur coal regeneration technology does not emit harmful substances during operation

### BRIEF DESCRIPTION OF THE DRAWINGS

FIG. 1 is a schematic perspective view of a system for the implementation of a method for desulfurization and dezincification of high-sulfur coal in accordance with the present invention.

FIG. 2 is a flow block diagram of the present invention.

FIG. 3 is a block diagram of the present invention, illustrating the interconnection relationship of the components of the system desulfurization and dezincification of high-sulfur coal in accordance with the present invention.

FIG. 4 is a diagram showing the relationship between various nitrogen contents and coal ranks.

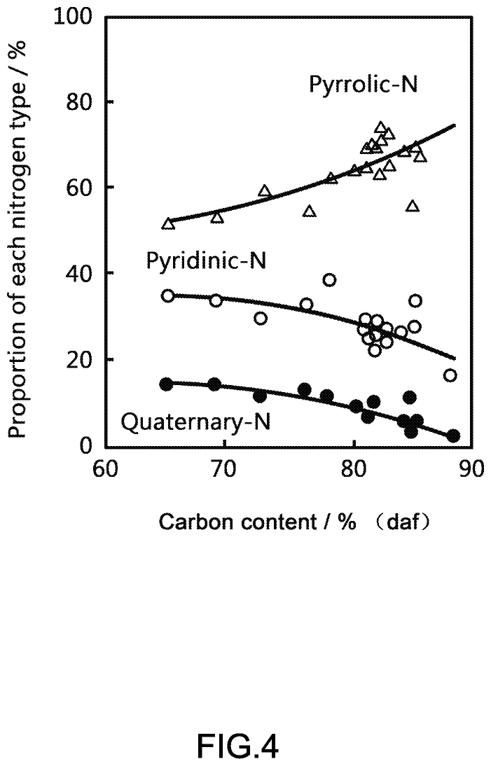

### DETAILED DESCRIPTION OF THE PREFERRED EMBODIMENT

The invention provides a method for desulfurization and dezincification of high-sulfur coal. The method is to pass the tap water into a high oxidation reduction electrocatalytic water equipment for enabling the pH value of the tap water to be reduced to 1-2, then to mix the specific ratio of the pH value 1-2 acid electrocatalytic water with high-sulfur coal subject to a specific formula and then to heat the mixture for a short period of time. In the process of heating, a large amount of H⁺ in the acid electrocatalytic water is reacted with sulfur and nitrogen in the high-sulfur coal, and hydrogen sulfide gas and ammonia gas are generated. In the process of heating, the volatilization of water vapor can effectively remove the sulfur and nitrogen in the high-sulfur coal, thereby improving the quality of the coal to meet the steelmaking requirements. The hydrogen sulfide and ammonia gases thus generated are collected into the ultra-gas battery flow device through a pipeline for further decomposition treatment. After high-sulfur coal desulfurization and dezincification, the total carbon content is increased, the quality is also improved correspondingly, and the level of steelmaking is reached, so that the high-sulfur coal which could not be used can be re-used as reusable coal.

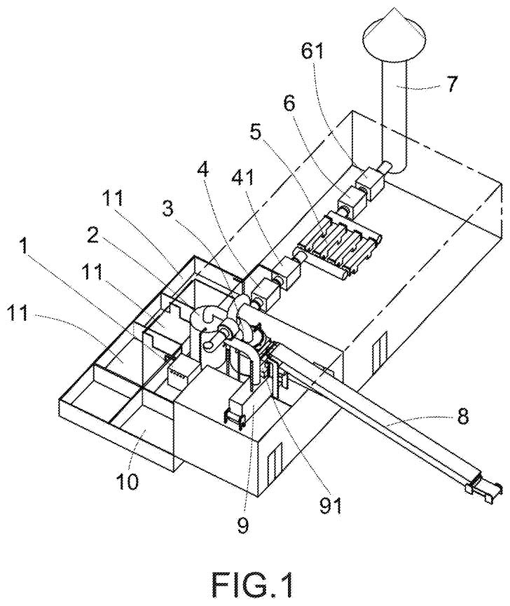

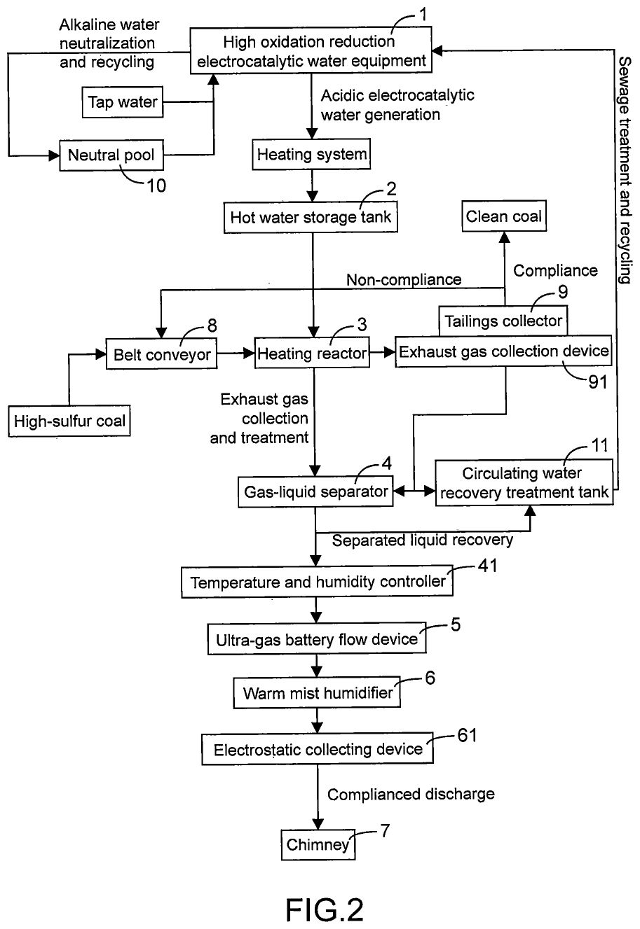

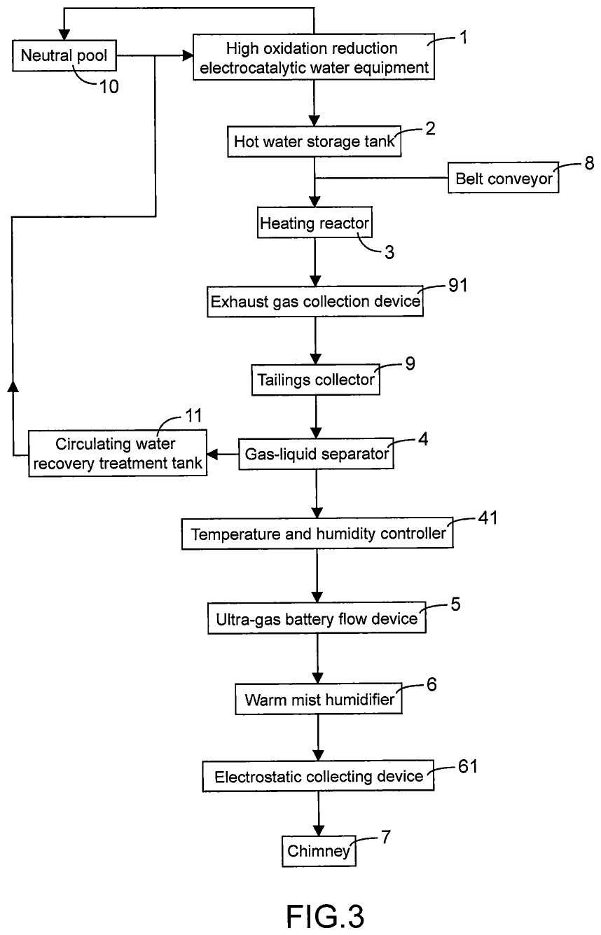

Referring to FIGS. 1 and 2, a system for the implementation of the aforesaid method for desulfurization and dezincification of high-sulfur coal comprises a high oxidation reduction electrocatalytic water equipment 1, a hot water storage tank 2, a heating reactor 3, gas-liquid separator 4, a temperature and humidity controller 41, an ultra-gas battery flow device 5, a electrostatic collecting device 61, a warm mist humidifier 6, a chimney 7, a belt conveyor 8, a high-sulfur coal collector 9, an exhaust gas collection device 91, a circulating water recovery treatment tank 11 and a neutral pool 10. The interconnection relationship of the foregoing components of the system is as shown in FIG. 3. Low-sulfur coal to be treated is delivered by the belt conveyor 8 into the heating reactor 3. The high oxidation reduction electrocatalytic water equipment 1 is a reactor for continuously generating high oxidation reduction water as described in China Utility Application 201120312616.4, no more instruction here. Tap water is passed into the high oxidation reduction electrocatalytic water equipment 1, enabling the pH value of the tap water to be reduced to 1-2. The pH value 1-2 acid electrocatalytic water thus obtained is mixed with the high-sulfur coal in the heating reactor 3 subject to a specific formula. Then, the heating reactor 3 is started to heat the mixture for a short period of time. In the process of heating, a large amount of H⁺ in the acid electrocatalytic water is reacted with sulfur and nitrogen in the high-sulfur coal. The final reaction produces a gas that separates the sulfur and nitrogen from the functional groups in the coal, producing gases such as hydrogen sulfide, sulfur dioxide and ammonia.

The exhaust gas generated by the heating process is guided into the gas-liquid separator 4 where water vapor is separated from the exhaust gas. The exhaust gas is soluble gas. The water vapor is then guided into the circulating water recovery treatment tank 11 while the exhaust gas is guided into the ultra-gas battery flow device 5 for treatment. The ultra-gas battery flow device 5 is the technology of China Patent Application 201310090394.X “Catalyst plasma and tunnel plasma containing the same” and 201010217588.8 “Uniform electric field dielectric discharge reactor” that were invented and filed by the applicant.

After the hydrogen sulfide is decomposed by the ultra-gas battery flow device 5, a variety of crystal structures of sulfur molecules are produced, and the small molecules of sulfur are agglomerated via the warm mist humidifier 6, and finally collected by the electrostatic collecting device 61. The excessive exhaust gas is discharged from the chimney 7.

After high-sulfur coal desulfurization and dezincification, the total carbon content increases, the quality is also correspondingly improved, and the level of clean coal is reached, so that the high-sulfur coal which could not be used can be re-used as reusable coal.

The heat source for the aforementioned hot water storage tank 2 is derived from the hot steam introduced into the pipeline after the high-sulfur coal is heated. The hot water storage tank 2 aims to reheat the electrocatalytic water produced by the high oxidation reduction electrocatalytic water equipment 1 in order to keep the electrocatalytic water in standby state at the same time, while saving heating energy.

In the processing, the high oxidation reduction electrocatalytic water equipment 1 produces both acidic and alkaline water. In order to save water resources, alkaline water is transferred to the neutral pool 10 for neutralization and rapid reduction for reuse. The neutral pool 10 is separated from the water of the circulating water recovery treatment tank 11.

Since the gas-liquid separator 4 performs the gas-liquid separation process, the water vapor will be condensed. The separated gas is a soluble gas. The condensed liquid will pass through the pipeline into the circulating water recovery treatment tank 11 for treatment. In order to save energy and environmental protection, the condensed liquid can be reused after treatment.

After the above desulfurization and dezincification treatment, the coal will be discharged together with coal water to the conveyor belt leading to the high-sulfur coal collector 9 for transmission (not shown). Coal water and tailings are solid-liquid separated by the high-sulfur coal collector 9, and the high-temperature steam generated by the exhaust gas collection device 91 is collected by a pipe and a fan (not shown). Separated coal water will be passed to the circulating water recovery treatment tank 11 for treatment and recycling.

What the invention claimed is:

1. A method for desulfurization and dezincification of high-sulfur coal, comprising the steps of:
passing tap water into a high oxidation reduction electrocatalytic water equipment for enabling the pH value of said tap water to be reduced to 1-2 so as to obtain a pH value 1-2 acid electrocatalytic water;
mixing a specific ratio of said pH value 1-2 acid electrocatalytic water with high-sulfur coal to be treated subject to a specific formula; and
heating the mixture of said pH value 1-2 acid electrocatalytic water and said high-sulfur coal for a predetermined period of time to let a large amount of H⁺ in said acid electrocatalytic water be reacted with sulfur and nitrogen in said high-sulfur coal and to further cause generation of hydrogen sulfide gas and ammonia gas where the volatilization of water vapor effectively removes the sulfur and nitrogen in said high-sulfur coal to improve the quality of the coal and the hydrogen sulfide gas thus generated is collected into an ultra-gas battery flow device through a pipeline for further decomposition treatment.

2. A system for the implementation of the method for desulfurization and dezincification of high-sulfur coal as claimed in claim 1, comprising a high oxidation reduction electrocatalytic water equipment, a hot water storage tank, heating reactor, a gas-liquid separator, a temperature and humidity controller, an ultra-gas battery flow device, an electrostatic collecting device, a warm mist humidifier, a chimney, a belt conveyor, a high-sulfur coal collector, an exhaust gas collection device, a circulating water recovery treatment tank and a neutral pool, wherein the high-sulfur coal to be treated is delivered by said belt conveyor into said heating reactor; the tap water is passed into said high oxidation reduction electrocatalytic water equipment, enabling the pH value of the tap water to be reduced to 1-2, then the pH value 1-2 acid electrocatalytic water thus obtained is mixed with the high-sulfur coal in said heating reactor subject to a specific formula, and then, said heating reactor is started to heat the mixture for a predetermined period of time; in the process of heating, a large amount of H⁺ in the acid electrocatalytic water is reacted with sulfur and nitrogen in the high-sulfur coal, and hydrogen sulfide gas and ammonia are generated; in the process of heating, the volatilization of water vapor effectively removes the sulfur and nitrogen in said high-sulfur coal, thereby improving the quality of the coal.

3. The system for desulfurization and dezincification of high-sulfur coal as claimed in claim 2, wherein the heat source for said hot water storage tank is derived from the hot steam introduced into the pipeline after said high-sulfur coal is heated; said hot water storage tank aims to reheat the electrocatalytic water produced by said high oxidation reduction electrocatalytic water equipment in order to keep the electrocatalytic water in standby state at the same time, while saving heating energy; said electrocatalytic water is heatable by independent electric heating.

4. The system for desulfurization and dezincification of high-sulfur coal as claimed in claim 2, wherein said gas-liquid separator separates generated hydrogen sulfide gas and ammonia gas from said acid electrocatalytic water, enabling the separated liquid to be delivered into said circulating water recovery treatment tank for treatment.

5. The system for desulfurization and dezincification of high-sulfur coal as claimed in claim 2, wherein said gas-liquid separator recovers the water vapor in the exhaust gas by condensation; in the process of gas-liquid separation through said gas-liquid separator, the liquid is condensed, the separated gas is a soluble gas, and the condensed liquid is guided through a pipeline into said circulating water recovery treatment tank for treatment and reuse.

6. The system for desulfurization and dezincification of high-sulfur coal as claimed in claim 2, wherein said exhaust gas collection device is mainly used to treat high temperature coal; in the process of discharging the heating reactor, a large amount of water vapor, sulfur dioxide and hydrogen sulfide gas are generated and collected by said exhaust gas collection device under an enclosed environment; after desulfurization and dezincification treatment, the coal is discharged together with coal water to a conveyor belt leading to said high-sulfur coal collector for transmission, and high-temperature steam generated by said exhaust gas collection device is collected by a pipe and a fan, and the separated coal water is passed to said circulating water recovery treatment tank for treatment and recycling.
